(19) United States
(12) Patent Application Publication
(10) Pub. No.: US 2003/0184549 A1
(43) Pub. Date: Oct. 2, 2003

(54) Image processing apparatus, and apparatus for and method of receiving processed image

(75) Inventors: Yong-Jae Kim, Gyeonggi-do (KR); Hyun-Suk Kim, Gyeonggi-do (KR); Young-Nam Oh, Gyeonggi-do (KR); Young-Hun Choi, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/216,838

(22) Filed: Aug. 13, 2002

(30) Foreign Application Priority Data
Mar. 26, 2002 (KR) 2002-16473

(51) Int. Cl. G09G 5/00; G06F 15/16; G09G 5/397

(52) U.S. Cl. 345/503; 345/546; 345/2.1

(57) ABSTRACT

An apparatus for processing image data to minimize a size of the image data and for communicating the minimized image data and an apparatus and method for receiving the processed image data. The image processing apparatus includes an acceleration processor for accelerating rendering of a graphic signal and processing the graphic image upon a request of a display apparatus, and an encoder for encoding a difference portion between a previous image and the acceleratively processed graphic signal. The image processing apparatus transmits the minimized image signals via a graphic controller which compresses the images while excluding redundant portions of the transmitted image signals. The apparatus for receiving the image signals decodes the compressed image signal and displays the image signal. A plurality of images which are transmitted from a plurality of computers may be simultaneously displayed on a screen of the display apparatus.

### CROSS REFERENCE TO RELATED APPLICATIONS

This application claims the benefit of Korean Application No. 2002-16473 filed Mar. 26, 2002, in the Korean Industrial Property Office, the disclosure of which is incorporated herein by reference.

### BACKGROUND OF THE INVENTION

1. Field of the Invention

The present invention relates to an image processing apparatus which minimizes a size of image data to be transmitted under a communication environment and transmits the minimized image data to a display apparatus, and an apparatus for and a method of receiving the processed image data.

2. Description of the Related Art

FIG. 1 is a block diagram of a general image processing apparatus such as a general graphic adapter or graphic card. Referring to FIG. 1, the general image processing apparatus includes a frame buffer 100 and an image processor 101. The image processor 101 processes an image signal, which is to be output to a display apparatus or a monitor (not shown), upon a request from a computer or a personal computer (not shown). The image processor 101 comprises a video input processor (VIP) 101-1, a memory interface 101-2, a bus interface 101-3, a graphic engine (GE) 101-4, a video processor (VP) 101-5, an overlay processor 101-6, a gamma random access memory (RAM) 101-7, and a digital-to-analog converter (DAC) 101-8.

A graphic controller (not shown), which stores a graphic signal and a video signal at different channels and individually processes the graphic and video signals, is frequently used in the conventional general image processing apparatus. For the processing of the graphic signal, the graphic controller provides a function of 2D/3D graphic acceleration. That is, where such a graphic controller is used with the image processing apparatus shown in FIG. 1, the graphic controller allows the GE 101-4 to perform rendering, directly accessing the frame buffer 100 in order to obtain required data. The graphic controller reads a graphic signal stored in the frame buffer 100 at predetermined times, combines the read graphic signal with a video signal in the overlay processor 101-6, and transmits the result to the DAC 101-8 via the gamma RAM 101-7. A converted analog signal is transmitted to the display apparatus. For the processing of the video signal, the VIP 101-1 stores the input video signal, which is output from an external source, in the frame buffer 100. The video signal is stored separately from the graphic signal because high-level processing capability is required to perform scaling, filtering, and color coordinate conversion on the video signal according to software instructions. However, where at least two video signals are to be output, e.g., playing back two moving image players, one video signal is processed by a video channel, and the other video signal is processed according to software instructions. Therefore, if a processing capability of a computer that reproduces the moving image is insufficient, the moving image is not reproducible without stopping.

FIGS. 2A-2C are views for explaining a difference between a previous image and a current image where a user selects a menu on,a web browser in order to see an image transmitted to a display apparatus. Since a high bandwidth is required in transmitting graphic and video signals via a telecommunication network (not shown), it is difficult to transmit the graphic and video signals by the conventional technique. For instance, where a graphic video signal is transmitted with color of 16 bits per pixel (bpp) at a 30 Hz (frame/second) rate at a generally used resolution of 1024×768 pixels, a bandwidth of the graphic video signal becomes 377 Mbps, (i.e., 1024×768×16×30=377 Mbps). The generation of such a high bandwidth signal is caused by a transmission of redundant data via the telecommunication network. A display screen of a web browser includes a menu which is selectable by a user as shown in FIG. 2A. Where the user selects the menu, items related to the selected menu appear on the screen as shown in FIG. 2B and an actual different portion between the previous image (FIG. 2A) and the current image (FIG. 2B) is only the menu portion as shown in FIG. 2C. However, a graphic controller transmits overlapped or redundant portions of the current image and the previous image, and thus, a quantity of transmitted data increases. For this reason, it is difficult to smoothly transmit graphic and video data.

### SUMMARY OF THE INVENTION

To solve the above and other problems, it is an object of the present invention to provide an image processing apparatus that minimizes a size of image signals to be transmitted to a display apparatus connected to a telecommunication network by compressing the image signals while excluding redundant portions of the image signals.

It is another object of the present invention to provide an apparatus and method for receiving an image signal whose size is minimized.

Additional objects and advantages of the invention will be set forth in part in the description which follows, and, in part, will be obvious from the description, or may be learned by practice of the invention.

Accordingly, to achieve the above and other objects of the present invention, there is provided an apparatus for processing an image, which is to be transmitted via a telecommunication network, the apparatus comprising an acceleration processor which accelerates rendering on a graphic signal and processing a graphic image corresponding to the graphic signal upon a request of the display apparatus, and an encoder which encodes a difference portion between a previous image and the acceleratively processed graphic signal and a related video signal.

To achieve the above and other objects of the present invention, there is also provided an apparatus for processing an image, which is to be transmitted to a display apparatus via a telecommunication network, the apparatus comprising an acceleration processor which acceleratively processes rendering on a graphic signal upon a request of the display apparatus, an encoder which encodes a graphic signal and a related video signal based on a difference portion between a previous image and the acceleratively processed graphic signal, and a communication network controller which controls a communication manner to transmit the encoded graphic and video signals to the display apparatus via the telecommunication network.

To achieve the above and other objects of the present invention, there is also provided an apparatus for processing an image, which is to be transmitted to a display apparatus via a telecommunication network, the apparatus comprising an encoder which encodes a difference portion between a previous image and a graphic image, which is to be processed upon a request of the display apparatus, and a related video signal.

To achieve the above and other objects of the present invention, there is also provided an apparatus for processing an image, which is to be transmitted to a display apparatus via a telecommunication network, the apparatus comprising: an encoder which encodes graphic and video signals based on a difference portion between a previous image and a graphic signal, which is processed upon a request of the display apparatus; and a communication network controller which controls a communication manner to transmit the encoded graphic and video signals to the display apparatus via a telecommunication network.

To achieve the above and other objects of the present invention, there is also provided an apparatus for receiving an image signal transmitted from a computer via a telecommunication network, the apparatus comprising: a communication network controller which controls the telecommunication network to receive encoded graphic and video signals, which are provided by the computer, by a predetermined communication method; a decoder which decodes the encoded graphic and video signals in real time; and an image processor which: acceleratively processes rendering on the decoded graphic signal and/or performing video processing, such as decoding, scaling, filtering and color coordinate conversion, on the decoded video signal; combines the graphic and video signals with each other and outputs the combined graphic and video signals as a signal to be displayed.

To achieve the above and other objects of the present invention, there is also provided a method of receiving an image signal transmitted from a computer via a telecommunication network, the method comprising: controlling a predetermined communication method, and receiving encoded graphic and video signals from the computer via the telecommunication network; decoding the received graphic and video signals in real time; performing acceleration processing on the decoded graphic image; and/or performing video processing, such as decoding, scaling, filtering and color coordinate conversion, on the video signal, and combining the graphic and video signals with each other; and displaying the combined signal.

### BRIEF DESCRIPTION OF THE DRAWINGS

The above and other objects and advantages of the present invention will become more apparent by describing in detail embodiments thereof with reference to the attached drawings in which:

FIG. 1 is a block diagram of a conventional image processing apparatus;

FIG. 2A is a block diagram of a web browser display of an image including a menu;

FIG. 2B is a block diagram of the web browser display shown in FIG. 2A which displays another image which is different from the image shown in FIG. 2A;

FIG. 2C is a view illustrating a difference between the images shown in FIGS. 2A and 2B;

FIG. 3 is a block diagram of a first embodiment of an image processing apparatus according to the present invention;

FIG. 4 is a block diagram of a second embodiment of an image processing apparatus according to the present invention;

FIG. 5 is a block diagram of a third embodiment of an image processing apparatus according to the present invention;

FIG. 6 is a block diagram of a fourth embodiment of an image processing apparatus according to the present invention; and

FIG. 7 is a block diagram explaining an apparatus and method for receiving a processed image signal according to the present invention.

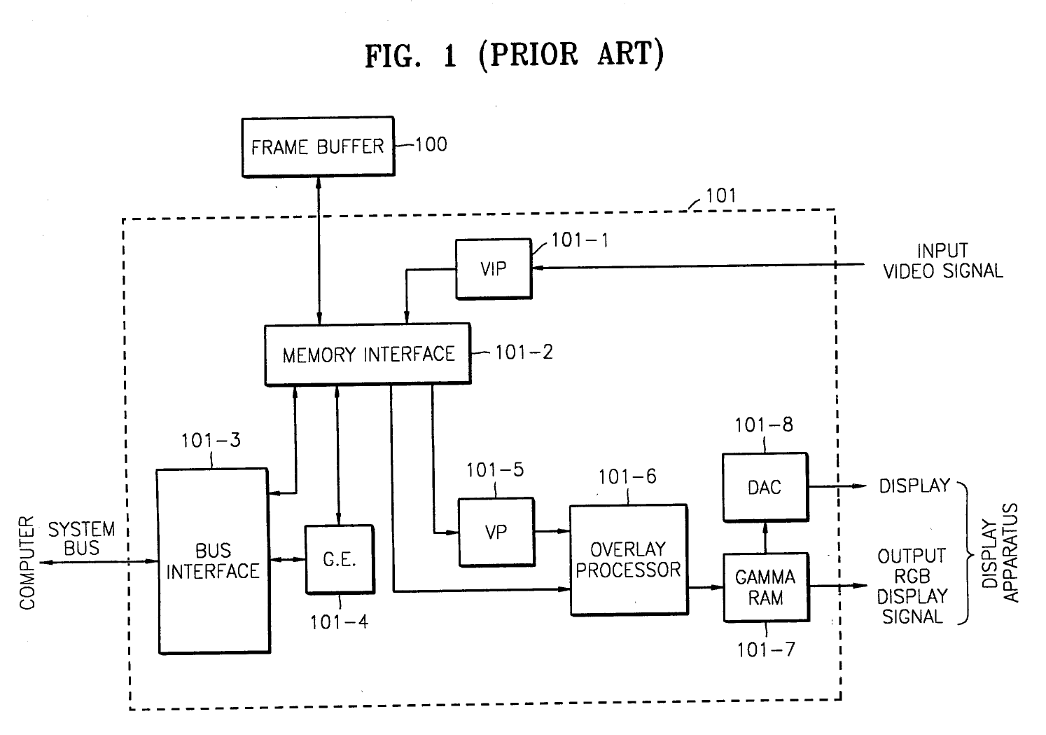

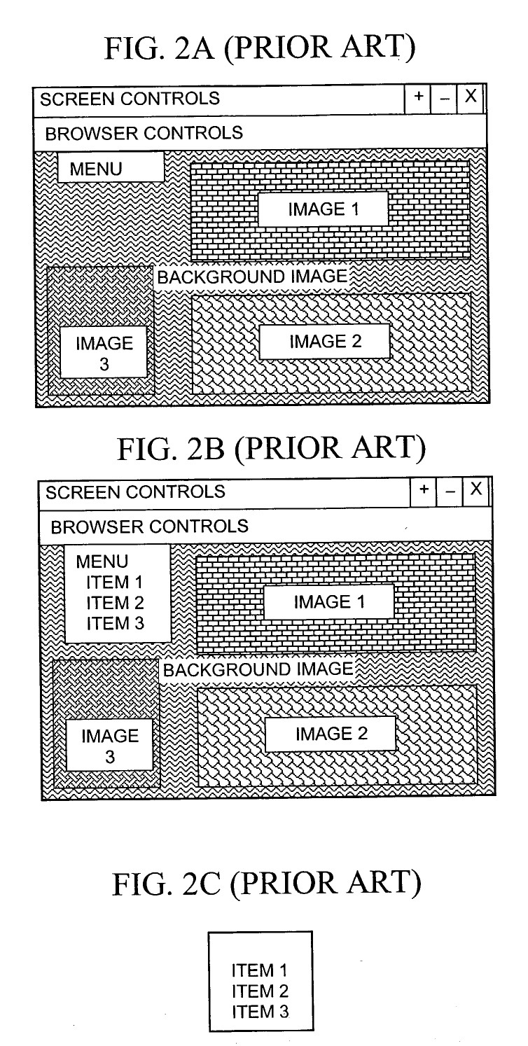

### DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

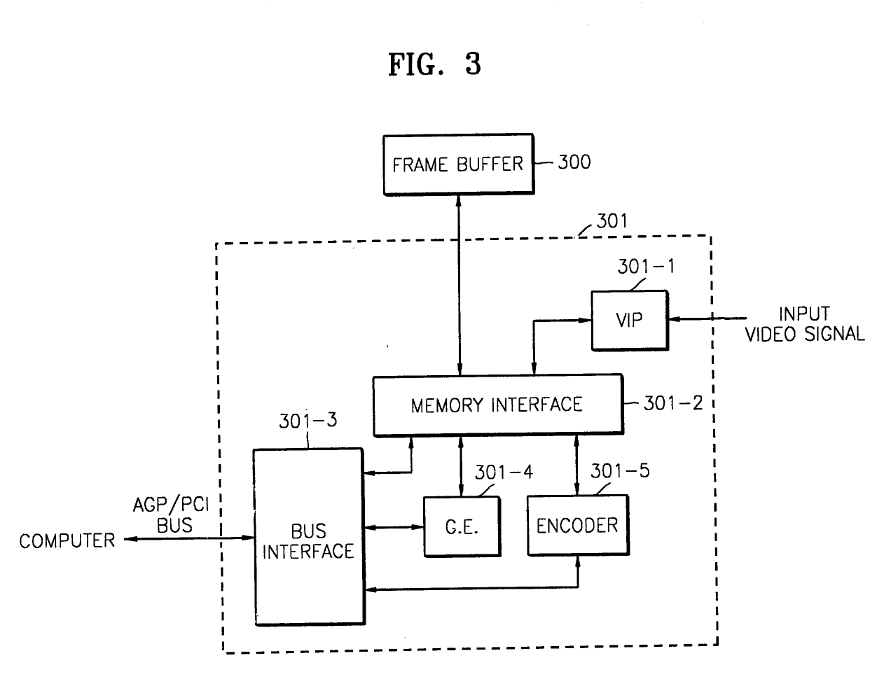

FIG. 3 is a block diagram of a first embodiment of an image processing apparatus according to the present invention. The image processing apparatus shown in FIG. 3 comprises a frame buffer 300 and an image processor 301. The image processor 301 comprises a video input processor (VIP) 301-1, a memory interface 301-2, a bus interface 301-3, a graphic engine (GE) 301-4, and an encoder 301-5.

The frame buffer 300 stores graphic and video signals processed by the image processor 301. The frame buffer 300 is divided into a region for storing graphic signals and a region for storing video signals.

The VIP 301-1 stores an input video signal, which is output from an external decoder (not shown), in the frame buffer 300 via the memory interface 301-2.

The GE 301-4, which is referred to below as an acceleration processor, acceleratively processes drawing a spot, a line, a square or a polygon and/or rendering a graphic signal such as bit block transfer and/or motion compensation (MC) and an inverse discrete cosine transform (IDCT) to decode a moving image in real time. For processing a three-dimensional (3D) graphic image, the GE 301-4 provides rendering such as texture mapping for a lifelike image, Gouraud shading for expressing a soft surface of an image, depth for processing a hidden line or surface, fog or alpha blending for heightening the special effect of an image, anti-aliasing for improving quality of a displayed image, masking for cutting a particular element of an image, dithering for providing an image of high-quality where the frame buffer 300 has a small capacity, and a logical operation for easily drawing or erasing a particular object on a screen.

The encoder 301-5 encodes a frame signal to be transmitted to a display apparatus, i.e., a difference portion between a previous image and a current image, to be proper for each protocol, and stores the result in a system memory (not shown) in a computer (not shown) via the bus interface 301-3 and an AGP/PCI BUS. The difference portion between the current image and the previous image may be represented as a bit map, a set of predetermined commands used during composition of the previous image and the current image, or a set of information regarding objects that are known in advance to a display apparatus (not shown). The encoder 301-5 encodes graphic and video signals, using the difference portion.

The encoded graphic and video signals are stored in the system memory in the computer. A compressed signal, which is stored in the system memory in the computer, is transmitted to the display apparatus via a telecommunication network (not shown) under the control of the computer.

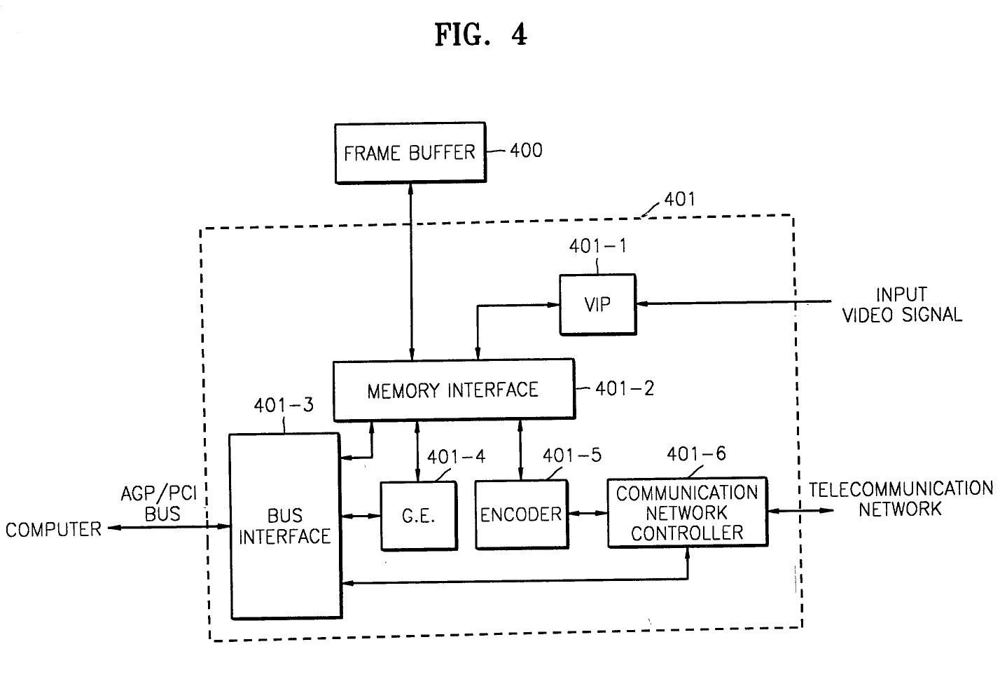

FIG. 4 is a block diagram of a second embodiment of an image processing apparatus according to the present invention. The image processing apparatus shown in FIG. 4 comprises a frame buffer 400 and an image processor 401. The image processor 401 comprises a VIP 401-1, a memory interface 401-2, a bus interface 401-3, a GE 401-4, an encoder 401-5, and a telecommunication network controller 401-6.

The frame buffer 400 stores graphic and video signals processed by the image processor 401 and is divided into a region for storing graphic signals and a region for storing video signals.

The VIP 401-1 stores an input video signal output, which is output from an external decoder (not shown), in the frame buffer 400 via the memory interface 401-2.

The GE 401-4, which will be referred to below as an acceleration processor, acceleratively processes motion compensation (MC) and an inverse discrete cosine transform (IDCT) for drawing a spot, a line, a square or a polygon, and/or rendering a graphic signal such as bit block transfer (BitBIt), and/or decoding a moving image in real time. For processing a 3D graphic image, the GE 401-4 provides rendering such as texture mapping for a lifelike image, Gouraud shading for expressing smooth surface of an image, depth for processing a hidden line or surface, fog or alpha blending for special effects of an image, anti-aliasing for improving the quality of an image, masking for cutting a particular element of an image, dithering for providing an image of high-quality where the frame buffer 400 has a small capacity, and a logical operation for easily drawing or erasing a particular object on a screen.

The encoder 401-5 encodes a frame signal to be transmitted to the display apparatus, i.e., a difference portion between a previous image and a current image, to be proper for each protocol, and stores the result in a system memory (not shown) of a computer (not shown) via the bus interface 401-3 or the frame buffer 400. Here, the difference portion between the current image and the previous image may be represented in a form of a bit map, a set of predetermined commands used from the previous image to the current image, or a set of information regarding objects that are known in advance to a display apparatus (not shown). The encoder 401-5 encodes graphic and video signals, using the difference.

The image processing apparatus according to the second embodiment comprises the telecommunication network controller 401-6 for controlling compressed graphic and video signals to be transmitted directly to a telecommunication network. Thus, unlike in the image processing apparatus according to the first embodiment, a signal processed by a graphic controller is not required to be received again by a computer and transmitted to the display apparatus via the telecommunication network. Graphic and video signals output from the communication network controller 401-6 may be transmitted directly to the display apparatus via the telecommunication network.

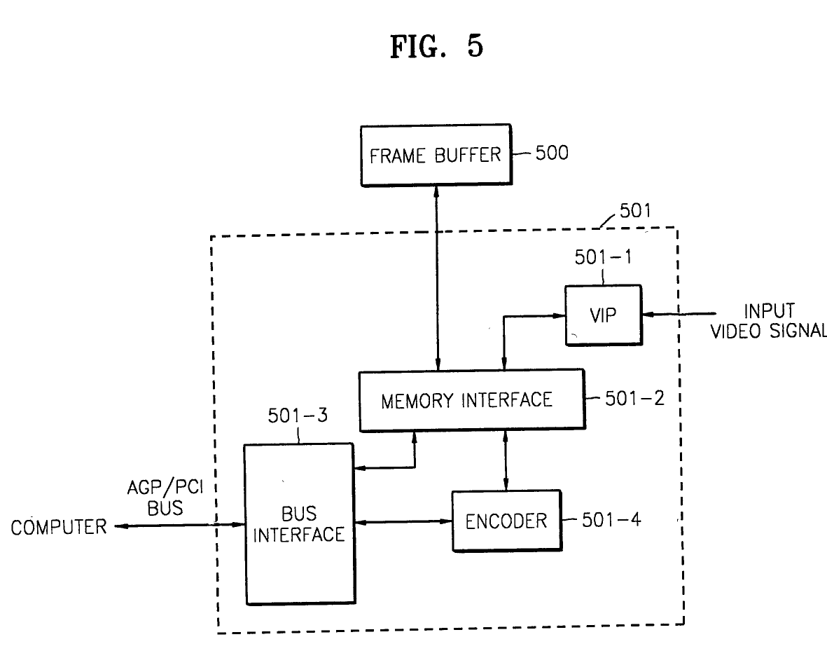

FIG. 5 is a block diagram of a third embodiment of an image processing apparatus according to the present invention. The image processing apparatus shown in FIG. 5 comprises a frame buffer 500 and an image processor 501. The image processor 501 comprises a VIP 501-1, a memory interface 501-2, a bus interface 501-3, and an encoder 501-4.

Referring to FIG. 5, the frame buffer 500 stores graphic and video signals processed by the image processor 501 and is divided into a region for storing graphic signals and a region for storing video signals.

The VIP 501-1 stores an input-video signal, which is output from an external decoder (not shown), to the frame buffer 500 via the memory interface 501-2.

The encoder 501-4 encodes graphic and video signals stored in the frame buffer 500. The encoder 501-4 encodes a frame signal to be transmitted to a display apparatus, i.e., a difference portion between a previous image and a current image, to be proper for each protocol, and stores the result in a system memory (not shown) in a computer (not shown) via the bus interface 501-3. The difference portion between the previous image and the current image may be represented in the form of a bit map, as a set of predetermined commands used from the previous image to the current image, or a set of information regarding objects that are known in advance to the display apparatus. The encoder 501-4 encodes graphic and video signals, using the difference.

The encoded graphic and video signals are stored in the system memory in the computer. A compressed signal stored in the system memory in the computer is transmitted to the display apparatus via a telecommunication network under the control of the computer.

The image processing apparatus according to the third embodiment does not include a graphic engine. Thus, the display apparatus receives the encoded signal and performs graphic rendering on the received signal or graphic processing thereof according to software instructions.

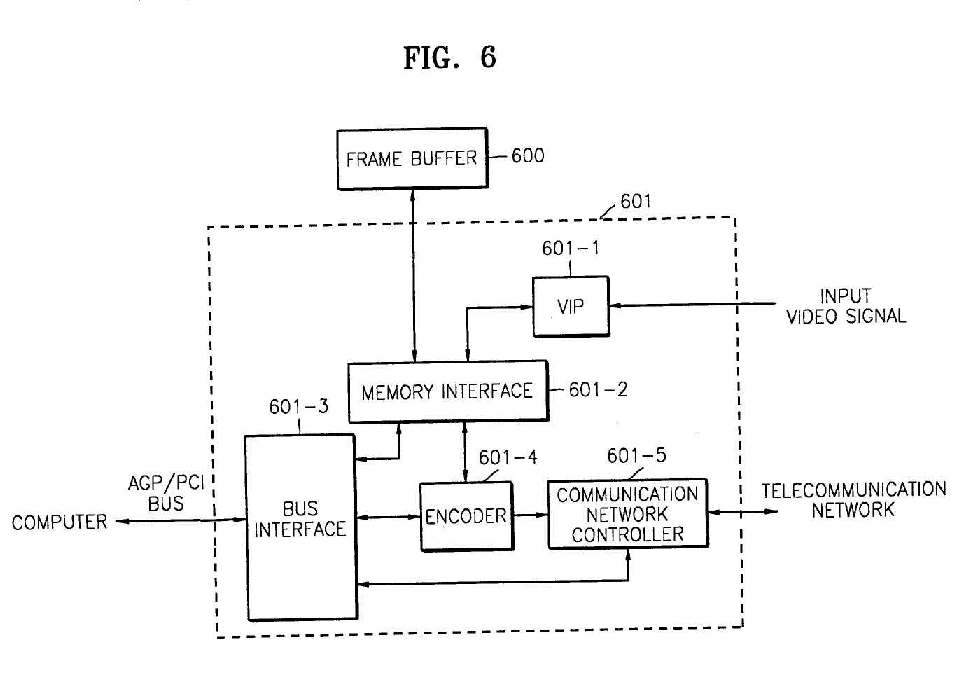

FIG. 6 is a block diagram of a fourth embodiment of an image processing apparatus according to the present invention. The image processing apparatus as shown in FIG. 6 comprises a frame buffer 600 and an image processor 601. The image processor 601 comprises a VIP 601-1, a memory interface 601-2, a bus interface 601-3, an encoder 601-4, and a communication network controller 601-5.

The frame buffer 600 stores graphic and video signals processed by the image processor 601 and is divided into a region for storing graphic signals and a region for storing video signals.

The VIP 601-1 stores an input video signal, which is output from an external decoder (not shown), in the frame buffer 600 via the memory interface 601-2.

The encoder 601-4 encodes graphic and video signals stored in the frame buffer 600. The encoder 601-4 encodes a frame signal to be transmitted to a display apparatus, i.e., a difference portion between a previous image and a current image, to be proper for each protocol, and stores the result in a system memory (not shown) in a computer (not shown) via the bus interface 601-3. Here, the difference portion between the previous image and the current image may be represented in the form of a bit map, as a set of predetermined commands used from the previous image to the current image, or as a set of information regarding objects that are known in advance to the display apparatus. The encoder 601-4 encodes graphic and video signals, using the difference.

The image processing apparatus according to the fourth embodiment does not include a graphic engine (GE). Therefore, the display apparatus receives the encoded signal, and performs graphic rendering on the received signal or performs graphic processing thereof according to software instructions.

Also, the image processing apparatus according to the fourth embodiment also includes the communication network controller 601-5 for controlling compressed graphic and video signals to be transmitted directly to a telecommunication network. For this reason, as in the first and third embodiments, the image processing apparatus shown in FIG. 6 may transmit graphic and video signals, which are output to the communication network controller 601-5, directly to the display apparatus via the telecommunication network, without intervention of the computer.

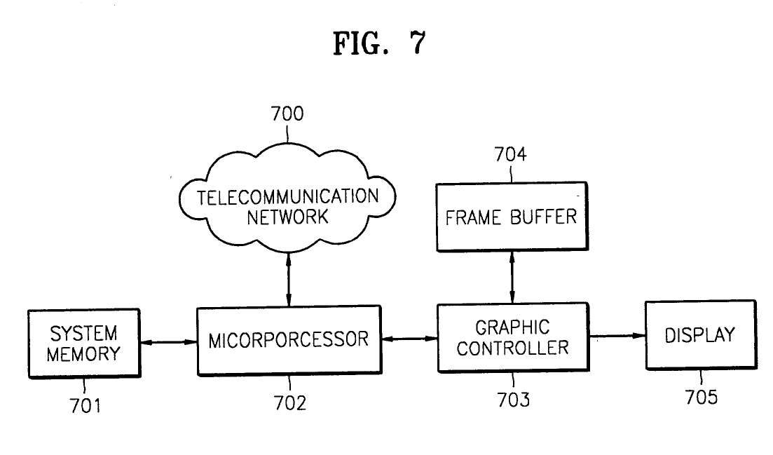

FIG. 7 is a block diagram for explaining an apparatus for and method of receiving a processed image according to the present invention. This apparatus includes a telecommunication network 700 comprising wire and/or wireless networks, a system memory 701, a microprocessor 702, a graphic controller 703, a frame buffer 704, and a display 705.

Here, this apparatus for receiving a processed image has the same functions as a display apparatus which is to be described hereinafter.

The system memory 701 stores various kinds of data for actuating the apparatus for receiving an image signal.

The microprocessor 702 controls the telecommunication network 700 so as to receive an image signal via the telecommunication network 700, and uncompresses a received compressed image signal in real time. Also, the microprocessor 702 may control a stand alone apparatus for receiving an image signal, i.e., an apparatus which is not connected to a computer, to access the telecommunication network 700.

The graphic controller 703 performs accelerative graphic processing on a graphic signal, which has not been acceleratively processed, from transmitted image signals, and performs rendering, such as scaling, filtering and color coordinate conversion, on a video signal which has not been previously processed. In an event that a signal is transmitted from an image processing apparatus, according to the first embodiment or the third embodiment, which does not include a graphic engine (GE), the graphic controller 703 performs rendering on a graphic signal that has not been processed, and performs rendering such as scaling, filtering and color coordinate conversion on a video signal that is not processed. The graphic controller 703 comprises the graphic engine, and performs rendering on the graphic signal by hardware or according to software instructions. Then, the graphic controller 703 combines the processed graphic signal and the video signal, and outputs the result as a signal to be displayed.

The frame buffer 704 stores or outputs all kinds of processed graphic and video signals.

The display 705 may have a structure of a personal digital assistant (PDA) or a set top box (STB), and displays a signal, which is combined with the graphic and video signals, output from the graphic controller 703.

An apparatus for receiving an image signal, according to the present invention, has a function of accessing peripheral equipment, as well as outputting a received signal. For instance, the apparatus may be connected to a mouse (not shown), a keyboard (not shown), a printer (not shown), or a scanner (not shown).

As described above, an image processing apparatus according to the present invention can smoothly transmit an image signal to a display apparatus via a telecommunication network, using a graphic controller for compressing image signals, which is to be transmitted to a display apparatus, while excluding overlapped or redundant portions between adjacent signals, thereby minimizing the size of data. Also, an apparatus for receiving an image signal, according to the present invention, encodes a compressed image signal and thus displays the image signal smoothly. Further, a plurality of images, which are transmitted from a plurality of computers, may be simultaneously displayed on a screen.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus for processing a graphic image, which is to be transmitted to a display apparatus via a telecommunication network, the apparatus comprising:
an acceleration processor which acceleratively processes rendering on a graphic signal corresponding to a current graphic image upon a request of the display apparatus; and
an encoder which encodes a graphic signal and a related video signal based on a difference portion between a previous graphic image and the acceleratively processed graphic signal.

2. The apparatus of claim 1 further comprising a storage portion which stores the graphic and video signals in different regions of the storage portion.

3. The apparatus of claim 1, wherein the difference portion is represented as one of a bit map image, a set of predetermined commands useable to change the previous image to the current image, and a set of information regarding objects that are known in advance to the display apparatus.

4. An apparatus for processing a graphic image, which is to be transmitted to a display apparatus via a telecommunication network, the apparatus comprising:
an acceleration processor which acceleratively processes rendering on a graphic signal corresponding to a current graphic image upon a request of the display apparatus;
an encoder which encodes a graphic signal and a related video signal based on a difference portion between a previous graphic image and the acceleratively processed graphic signal; and
a communication network controller which controls a communication manner to transmit the encoded graphic and video signals to the display apparatus via the telecommunication network.

5. The apparatus of claim 4 further comprising a storage portion which stores the graphic and video signals in different regions of the storage portion.

6. The apparatus of claim 4, wherein the difference portion is represented as one of a bit map image, a set of predetermined commands useable to change the previous image to the current image, and a set of information regarding objects that are known in advance to the display apparatus.

7. An apparatus for processing an image, which is to be transmitted to a display apparatus via a telecommunication network, the apparatus comprising:
an encoder which encodes a graphic signal and a related video signal based on a difference portion between a previous image and a graphic image which is to be processed upon a request of the display apparatus.

8. The apparatus of claim 7 further comprising a storage portion which stores the graphic and video signal, prior to encoding, in different regions of the storage portion.

9. The apparatus of claim 7, wherein the difference portion is represented as one of a bit map image, a set of predetermined commands useable to change the previous image to the current image, and a set of information regarding objects that are known in advance to the display apparatus.

10. An apparatus for processing an image, which is to be transmitted to a display apparatus via a telecommunication network, the apparatus comprising:
an encoder which encodes and outputs graphic and video signals based on a difference portion between a previous image and an input graphic signal, which is processed upon a request of the display apparatus; and
a communication network controller which controls a communication manner to transmit the encoded graphic and video signals to the display apparatus via the telecommunication network.

11. The apparatus of claim 10 further comprising a storage unit which stores the graphic and video signals prior to encoding, in different regions of the storage unit.

12. The apparatus of claim 10, wherein the difference portion is represented as one of a bit map image, a set of predetermined commands useable to change the previous image to the current image, and a set of information regarding objects that are known in advance to the display apparatus.

13. An apparatus for receiving an image signal transmitted from a computer via a telecommunication network, the apparatus comprising:
a communication network controller which controls the telecommunication network to receive encoded graphic and video signals, which are provided by the computer, by a predetermined communication method;
a decoder which decodes the encoded graphic and video signals in real time; and
an image processor which acceleratively processes rendering on the decoded graphic signal and/or performs video processing on the decoded video signal, combines the graphic and video signals with each other, and outputs the result as a signal to be displayed.

14. The apparatus of claim 13 further comprising a storage unit which stores or outputs the graphic and video signals that are processed by at least one of the communication network controller, the decoder, and the image processor.

15. The apparatus of claim 13, wherein the communication network controller controls the apparatus to access the telecommunication network without assistance of a network interface card of the computer.

16. A method of receiving an image signal transmitted from a computer via a telecommunication network, the method comprising:
controlling a predetermined communication method, and receiving encoded graphic and video signals from the computer via the telecommunication network;
decoding the graphic and video signals in real time;
performing acceleration processing on the decoded graphic image and/or performing video processing on the video signal, and combining the graphic and video signals; and
displaying the combined signal.

17. The apparatus of claim 13, wherein:
the communications network controller controls the telecommunication network to receive a plurality of the encoded graphic and video signals from a plurality of computers;
the decoder decodes each of the plurality of encoded graphic and video signals in real time; and
the image processor acceleratively processes rendering on the decoded graphic signals and/or performs video processing on the decoded video signals, combines the plurality of graphic and video signals, and outputs the result as a signal to be displayed.

18. An apparatus for communicating image data from a computer to a display, comprising:
an image processing apparatus which accelerates rendering of a graphic signal corresponding to a current graphic image and determines redundancies between the current graphic image and a previous graphic image;
an encoder which encodes signals to be transmitted based on excluding the redundancies; and
a communications controller which transmits the encoded signals.

19. An apparatus for communicating image data from a computer to a display, comprising:
a processor which operates according to software instructions and which:
accelerates rendering of a graphic signal corresponding to a current graphic image and determines redundancies between the current graphic image and a previous graphic image;
encodes signals to be transmitted based on excluding the redundancies; and
controls transmission of the encoded signals to the display device.
